(19) United States
(12) Patent Application Publication
(10) Pub. No.: US 2003/0155390 A1
(43) Pub. Date: Aug. 21, 2003

(54) Adjustable hitch mounted cargo carrier

(76) Inventors: Marty Williams, Colorado Springs, CO (US); Matthew Drabczyk, Hudson, CO (US)

Correspondence Address: GLENN L WEBB, P.O. BOX 951, CONIFER, CO, 80433

(21) Appl. No.: 09/683,820

(22) Filed: Feb. 20, 2002

(51) Int. Cl. B60R 9/00; B60R 11/00

(52) U.S. Cl. 224/521; 224/519

(57) ABSTRACT

A cargo carrier for mounting onto a vehicle. The cargo carrier includes two parallel cylindrical tubes extending from a connection frame that engages the vehicle. A carrier frame includes two parallel tubes that engage over the connection frame tubes. The carrier frame is able to slide rearwardly relative to said connection frame and said vehicle to allow access to the rear of the vehicle.

### BACKGROUND OF INVENTION

The use of cargo carriers mounted to vehicles are very popular for traveling, for carrying sports equipment and even for hauling light cargo. Typically these carriers are designed to mount on the hitch receiver of a vehicle, such as a passenger car, sports utility vehicle, van or even pickup trucks. These cargo carriers include a tube member that is inserted into the receiver hitch or even mounted onto the hitch ball of the vehicle. These cargo carriers are normally mounted closely adjacent to the rear of the vehicle in order to reduce the torque loading on the rear of the vehicle that can create difficulties in the handling and performance of the vehicle.

One problem that results from the use of such cargo carriers is the inability to access the rear of the vehicle. Most such vehicles have a tailgate or door that swings down, up or sideways to allow access into the rear of the vehicle. Since most cargo carriers are mounted closely to the rear of the vehicle, this access is denied. Many such cargo carriers must be dismounted from the vehicle to allow access into the vehicle.

There have been a number of attempts to solve this problem. For example, carriers that are slidable or telescoping relative to the hitch mount are disclosed in U.S. Pat. Nos. 5,586,702 and 5,881,937, both issued to Sadler. Other such types of cargo carriers are disclosed in U.S. Pat. No. 5,310,100, issued to Liscinsky; U.S Pat. No. 5,570,825, issued to Coma; U.S. Pat. No. 6,145,720, issued to Comeau; and U.S. Pat. No. 6,152,341 issued to LeMay et al. Also, these patents and others, including U.S. Pat. No. 4,744,590 issued to Chesny and U.S. Pat. No. 5,224,636, issued to Bounds disclose cargo carriers that pivot downwardly to allow access into the vehicle.

These structures have varying amounts of success. However, they all include common elements of a single carrier tube that slides within or relative to the hitch receiver. The carrier tube may also include an intermediate connection member as well. The carrier tube and/or the intermediate connection member are always formed of square tubing or bars. This creates a number of problems with the use of such carriers.

One such problem is the sway of the carriers relative to the single carrier tube. This is particularly pronounced if the carrier is imbalanced from the load within the carrier. The load creates a moment along the upper surface of that single carrier tube that not only causes the carrier to sway, but can also detrimentally impact the handling and performance of the vehicle.

Another problem with these types of carriers is the friction between the rectangular tubing or bars. The carrier tube or connection member, in the previous carriers, slide within the hitch receiver or intermediate connection member. Since these are substantially rectangular, there is a substantially amount of friction to be overcome. This can cause difficulty in moving loaded carriers. This is further exacerbated by the tightness of the fit between the hitch receiver and the carrier tube. This tightness is necessary in order to reduce the relative movement or “slop” between the hitch receiver and the carrier. Failure to reduce the relative movement can cause the carrier to sway relative to the vehicle impacting the handling and performance of the vehicle.

Another problem with the use of the prior carriers is that the shape and configuration of the connection tubes or bars causes the load to be concentrated on certain parts of the hitch receiver and/or connection members. This necessitates overdesign of these members, thus increasing the weight, size and cost of the carriers.

These and other problems have created a need for hitch mounted carriers that are more efficient, more stable, and easier to use.

### SUMMARY OF INVENTION

The present invention solves these problems and others by providing a stable frame that enables the cargo container to be moved relative to the vehicle while still maintaining stability of the container in use. The frame also enables easier movement of the cargo container. Also, the overall weight of the carrier frame is reduced while improving the stability and strength of the carrier frame.

In one preferred embodiment, the cargo carrier includes a connection member or spine that is secured to the vehicle. Two parallel cylindrical tubes extend from the connection member. A carrier frame includes opposing tubes that engage over the connection member tubes. This enables the carrier frame to slide on the connection member tubes fully supported. Fasteners can secure the carrier frame from movement for travel. The use of the cylindrical tubes reduces the friction of the movement while maintaining the integrity of the structure. The use of more than one tube minimizes the sway of the cargo container.

In other embodiments, the connection tubes are mounted to pivot relative to the connection tube. This enables the carrier frame to pivot out of the way to allow access to the rear of the vehicle.

Another embodiment uses an open channel with rollers to allow the carrier frame to move relative to the connection frame. Also, “C” shaped tubes are also able to be used.

These features and others will be evident from the detailed description of preferred embodiments, the claims and the drawings.

### BRIEF DESCRIPTION OF DRAWINGS

FIG. 1 is an illustration of a cargo box mounted to the rear of a vehicle.

FIG. 2 is an exploded illustration of the cargo carrier of a preferred embodiment of the present invention.

FIG. 3 is a view of the assembled cargo carrier of the embodiment of FIG. 2.

FIG. 4 is a view of the cargo carrier of the embodiment of FIG. 2 mounted to the hitch receiver of a vehicle.

FIG. 5 is an illustration of the cargo carrier of FIG. 4 moved to a rearward position relative to the vehicle.

FIG. 6 is an exploded illustration of an alternative embodiment.

FIG. 7 is an exploded illustration of another alternative embodiment.

FIG. 8 is an exploded illustration of another alternative embodiment.

FIG. 9 is an exploded illustration of another alternative embodiment.

FIG. 10 is a cross-section of the embodiment of FIG. 9 taken along lines A-A.

### DETAILED DESCRIPTION

The present invention provides a hitch mounted cargo carrier apparatus that solves many of the problems of the prior cargo carriers. In a preferred embodiment of the present invention, a connection apparatus for mounting not only cargo carriers, but other types of hitch mounted devices to a vehicle is provided. It is to be expressly understood that the descriptive embodiments provided herein are for explanatory purposes only and are not meant to unduly limit the scope of the present invention. Other embodiments and modifications are considered to be within the scope of the claimed invention.

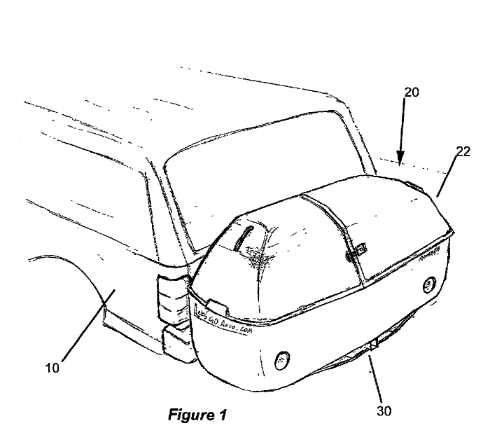

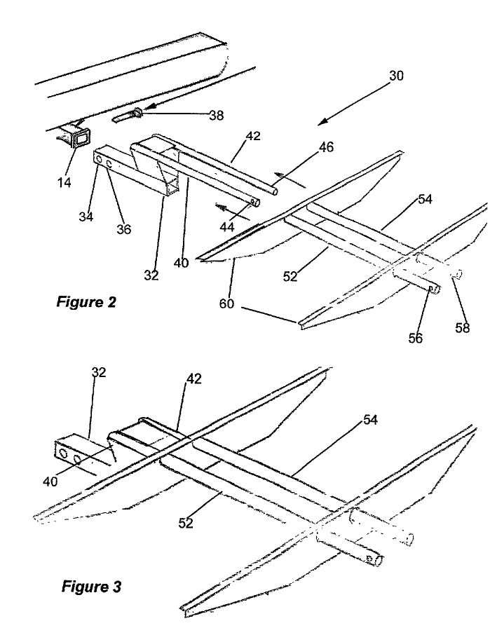

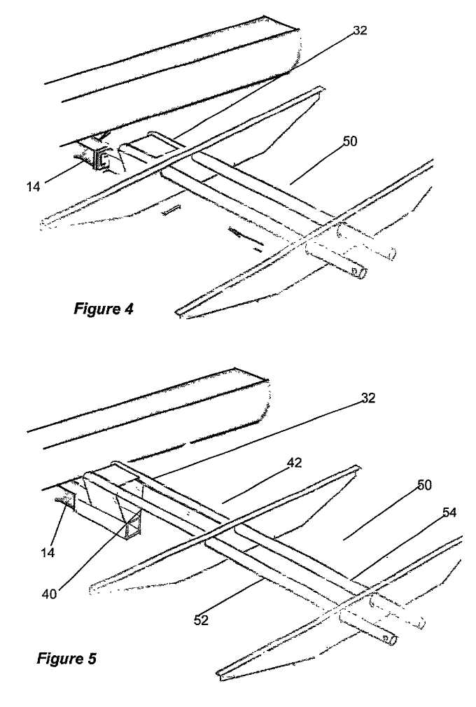

In one preferred embodiment of the present invention illustrated in FIGS. 1 3, a cargo carrier 20 is mounted on a vehicle 10. Cargo carrier 20 includes a cargo box 22 and a frame 30. It is to be expressly understood that the cargo box 22 does not form any part of the present invention. Other types of carriers could be used, such as platforms, bicycle racks, etc.

As shown in FIG. 2, frame 30 a connection frame that includes connection member 32 having holes 34, 36 for receiver hitch pin 38. Connection member 32 also includes two parallel longitudinally extending circular tubes 40, 42. In the embodiment illustrated in FIG. 2, the circular tubes 40, 42 are mounted in a raised manner above the connection member 32. However, the tubes 40, 42 could also be mounted on top of, below or alongside of connection member 32. he circular tubes 40, 42 extend a length substantially equal to the length of the carrier frame 50, although this is not necessarily required. The length could be longer or shorter as desired. Fastener holes 44, 46 are formed in the circular tubes 40, 42 along the length of the tubes. The tubes 40, 42 may be hollow or solid.

Frame 50, as shown in FIG. 2, includes two receiving tubes 52, 54 having inner dimensions and shape similar to the outer dimensions and shape of the two parallel tubes 40, 42. Tubes 52, 54 are mounted to be able to mount over the tubes 40, 42. It is to be expressly understood that tubes 52, 54 and tubes 40, 42 could be reversed, that is, the tubes 52, 54 could slide into the tubes 40, 42 or alternatively, one tube could slide into the opposing tube while the other adjacent tube could slide over the opposing tube. Fastening holes 56 and 58 are formed in tubes 52, 54 in a location to match the fastener holes 44, 46 when the carrier body frame 50 is securely mounted onto the tubes 40, 42.

Carrier frame 60 also includes support members 60, 62 extending transversely from the tubes 52, 54. A cargo carrier or other apparatus can be secured onto the support members 60, 62 by well-known mechanism.

In use, the carrier frame 50 is inserted onto the connection member 32 by inserting tubes 52, 54 over tubes 40, 42 (or as discussed above). Once the carrier frame 50 is securely and fully engaged onto the connection member 32, fasteners are inserted through holes 56, 44 and 58, 46, respectively to secure the carrier body frame 50 onto the connection member 32. Connection member 32 is (or already has been) inserted into the hitch receiver 14 of the vehicle 10. Fastener 38 is inserted through the hitch receiver 14 and through one of the holes 34, 36. A cargo carrier can be fastened (or already has previously been fastened) onto the carrier frame 50.

Once the carrier frame 50 and connection member 32 has been secured, the carrier 20 is ready for use. The twin tube system (40, 42, and 52, 54) provides secure support for the cargo and minimizes sway of the cargo carrier. If access is desired for the rear of the vehicle, then the fasteners are removed from fastener holes 44, 56, and 46, 58 and the carrier frame is slid backwards relative to the connection member 32 and tubes 40, 42 as shown in FIG. 5. The shape and size of the tubes 40, 42 and 52, 54 reduce the friction from this movement and also provides a smoother more effortless movement. When access to the rear of the vehicle is no longer needed, then the carrier frame is returned to its original position and the fasteners reinserted.

The carrier 20 also enables the quick change of cargo devices. For example, several different cargo frames 50 may have different equipment or devices secured thereto. The use of the connection frame as discussed above enables the quick change of these different frames onto the connection frame.

Another embodiment is illustrated in FIG. 6. This embodiment is similar to the above embodiment, except that the two parallel tubes 140,142 are spaced vertically as opposed to horizontally. Similarly, the two parallel tubes 152, 154 are also spaced vertically to one another. The operation of the carrier frame 50 and the connection member 32 remains the same.

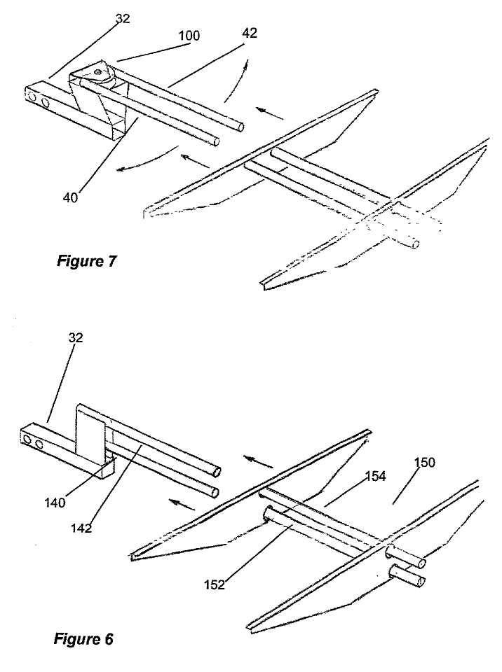

Another embodiment is illustrated in FIG. 7. This embodiment is similar to the embodiment illustrated in FIGS. 2 5 except that the carrier frame is horizontally pivotable relative to the vehicle to allow access to the vehicle. Hinge pivot 100 is mounted to connection member 32 and may be pivoted horizontal relative to connection member 32. A locking pin (not shown) locks the hinge pivot 100 to prevent accidental movement of the hinge pivot and carrier frame 50. Tube members 40, 42 are mounted to the hinge pivot 100. The carrier frame 50 is then mounted to the tube members 40, 42 in a manner as discussed above. The locking pin is simply removed to allow the carrier frame 50 and any cargo carrier mounted onto it to be pivoted in either direction.

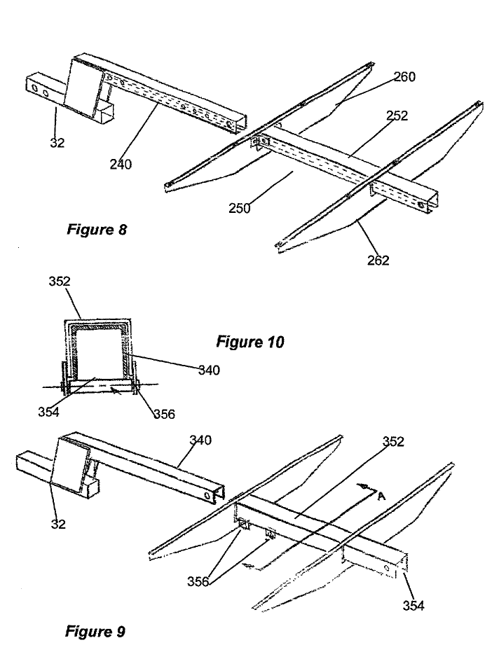

An alternative embodiment is shown in FIG. 8. This embodiment is similar to the first described embodiment except that the twin carrier tube design is not used. Instead, a “C” channel member 240 is secured to the connection member 32. Carrier frame 250 includes a mating “C” channel 252 that slides over and engages channel member 240. Support members 260, 262 are secured to channel member 252 for supporting a cargo container or other device. The carrier frame 250 is mounted to the vehicle by sliding channel member 252 over (or into) channel member 240. A fastener is inserted through holes 242 and 252 to secure the carrier frame in place. The carrier frame 250 can be easily slid backwards once the fastener is released to allow access into the rear of a vehicle onto which the cargo apparatus is mounted. The channel member 240 can also be mounted to pivot relative to the connection member 32 as discussed in the embodiment of FIG. 7.

Another alternative embodiment is illustrated in FIGS. 9 and 10. An open channel member 340 is secured to connection member 32. Open channel member 340 includes a bottom opening extending the length of the channel member. Alternatively the bottom opening of channel member 340 could be partially or entirely closed. However, carrier frame member 352 includes a bottom opening 354 extending substantially the length of the member 352. One or more rollers 356 are mounted adjacent the bottom opening 354, as shown in FIGS. 9 and 10. As the carrier frame member 352 is mounted and/or slid over the channel member 340, the rollers provide support and also reduce friction during the movement. The carrier frame member can be locked into place on the connection member 32 by the use of a fastener extending through holes 344, 358.

These and other embodiments are included in the present invention as set forth in the ensuing claims. It is to be expressly understood that these descriptive embodiments are intended for explanatory purposes only and are not meant to limit the scope of the appended claims.

1. A cargo carrier for mounting to the rear of a vehicle, said cargo carrier comprising:
a connection frame for mounting onto a vehicle;
a first connection tube mounted to said connection frame;
a second connection tube mounted to said connection frame and adjacent thereto;
a carrier frame;
a first carrier tube mounted to said carrier frame and having inner dimensions substantially similar to the outer dimensions of said first connection tube and spaced to slide over said first connection tube;
a second carrier tube mounted to said carrier frame and having inner dimensions substantially similar to the outer dimensions of said second connection tube and spaced to slide over said second connection tube; and at least one fastener for securing said carrier frame to said connection member to prevent relative movement.

2. The cargo carrier of claim 1 wherein said first connection tube and said second connection tube are substantially cylindrical.

3. The cargo carrier of claim 1 wherein said first connection tube and said second connection tube are pivotable relative to said connection frame.

4. The cargo carrier of claim 1 wherein said first connection tube and said second connection tube are mounted substantially parallel to one another.

5. The cargo carrier of claim 1 wherein said first connection tube and said second connection tube are mounted substantially horizontally parallel to one another.

6. The cargo carrier of claim 1 wherein said first connection tube and said second connection tube are mounted substantially vertically parallel to one another.

7. The cargo carrier of claim 1 wherein said connection frame includes more than two connection tubes and said cargo frame includes an equal number of carrier tubes for engagement with said connection tubes.

8. A cargo carrier for mounting to the rear of a vehicle, said cargo carrier comprising:
a connection frame for mounting onto a vehicle;
at least one connection tube mounted to said connection frame and having a substantially circular shape;
an equal number of carrier tubes as said at least one connection tube mounted to said carrier frame and having inner dimensions substantially similar to the outer dimensions of said at least one connection tube and spaced to slide over said at least one connection tube; and
at least one fastener for securing said carrier frame to said connection member to prevent relative movement.

9. The cargo carrier of claim 8 wherein said at least one connection tube includes two cylindrical connection tubes.

10. The cargo carrier of claim 8 wherein said at least one connection tube is mounted to pivot relative to said connection frame.

11. A cargo carrier for mounting to the rear of a vehicle, said cargo carrier comprising:
a connection frame for mounting onto a vehicle;
at least one connection tube mounted to said connection frame; an equal number of carrier tubes as said at least one connection tube mounted to said carrier frame and having inner dimensions substantially similar to the outer dimensions of said at least one connection tube and spaced to slide over said at least one connection tube;
an open channel on one of the surfaces of said carrier tubes; and at least one fastener for securing said carrier frame to said connection member to prevent relative movement.

12. The cargo carrier of claim 11 wherein said carrier tubes including at least one roller mounted adjacent said open channel on said carrier tubes.

13. The cargo carrier of claim 11 wherein said at least one connection tube is mounted to pivot relative to said connection frame.
